(19) United States
(12) Patent Application Publication
(10) Pub. No.: US 2021/0233179 A1
(43) Pub. Date: Jul. 29, 2021

(54) METHOD FOR DESIGNING COMPOSITE-INDEX AGRICULTURAL INSURANCE PRODUCT AND PRODUCTS THEREFROM

(71) Applicant: Beijing Normal University, Beijing (CN)

(72) Inventors: Zhao ZHANG, Beijing (CN); Ziyue LI, Beijing (CN); Yuchuan LUO, Beijing (CN); Jing ZHANG, Beijing (CN); Fulu TAO, Beijing (CN)

(21) Appl. No.: 17/026,756

(22) Filed: Sep. 21, 2020

(30) Foreign Application Priority Data
Jan. 23, 2020 (CN) 202010075947 .4

(51) Int. Cl. G06Q 40/08; G06Q 50/02; G06F 17/18

(52) U.S. Cl. CPC G06Q 40/08; G06F 17/18; G06Q 50/02

(57) ABSTRACT

The invention discloses a method for designing composite-index agricultural insurance and a product therefrom, the method including: S1, Obtaining the required data in the study area; S2, Constructing the climatic simulation scenarios under ideal and disaster, S3, Calibrating the site-level crop growth model, then inputting the simulation scenarios of S2 to get the corresponding output of each site; S4, Calculating the premium rate of agricultural insurance based on the output of S3; S5, Choosing several candidate indicators and using these indicators to construct a composite index; S6, Building a vulnerability model that reflects the response between the yield loss rate and the composite index through combining the composite index of S5 with the output of S3, then determine how to pay out based on the vulnerability model and the premium rate.

### CROSS-REFERENCE TO RELATED APPLICATION

This application claims the benefit of Chinese Application No. 202010075947.4, filed on Jan. 23, 2020. The entirety of this application is incorporated herein by reference.

### FIELD OF THE APPLICATION

The present invention relates to the field of agricultural information technology.

Specifically, it relates to a method for designing a composite-index agricultural insurance and a product therefrom.

### BACKGROUND

Climatic risks pose significant challenges to agriculture worldwide which leads to drastic fluctuation and accidental loss of yield. As a disaster risk transfer Management method, agricultural insurance is intensively implemented because of its importance in boosting agricultural production, relieving the relief pressure of the government, and guaranteeing the life of farmers. In China, the agricultural insurance is booming. From 2007 to 2012, the cumulative premiums had exceeded 60 billion RMB and ranked second in the world, with an average annual growth rate of 85%. Moreover, the agricultural insurance paid more than 40 billion RMB to over 70 million rural households, nearly 600 RMB per household, accounting for about 10% of the rural per capita annual income.

However, the complexity of the actual situation dampens the performance of agricultural insurance. The traditional compensation-based insurance always suffered from moral hazard, adverse selection, high administrative costs, and long delays in implementation. Especially in remote areas, it has been trapped in the dilemma of identifying risk and assessing the damage. According to the implementation over the years, we found such insurances are often disappointing, with many ending up in failure or requiring massive subsidies to sustain adoption. Currently, the weather index-based insurance products have become highly promising alternatives to traditional ones. It has the advantage that both the insurer (insurance company) and the insured (the farmer) have information symmetric; that is, they can both quickly obtain all the information about the selected index. Therefore, the weather index-based insurance can effectively avoid the farmers turning to riskier agricultural management to defraud the insurance money, and it can also reduce the high labor costs that insurance companies use to survey and assess losses. Nevertheless, there are still many deficiencies in the index-based agricultural insurance products:

(1) The Lack of Accurate Losses Data

For index insurance, the key is the determination of the “loss-index” relationship. According to its definition, the “index” should be an easily accessible open data with a long time series. Therefore, the source of the “loss” data is particularly important. At present, there are two familiar data sources: The statistical-based loss data from the Yearbook of Meteorological Disasters in China; and The policy-based loss data from insurance companies. The first dataset has extensive coverage and long duration in China, while the record formats may differ between regions and have omissions in some years. The second dataset is more specific and reliable and well reflects the different loss response of different regions. However, the agricultural insurance in China is only with relatively short development (<20 years), and the coverage type and scope of each insurance company are relatively limited. Thus, this dataset is insufficient to support the establishment of a good “index-loss” relationship. In general, the loss data are challenging to achieve both quantity and quality.

(2) The Low Selection Dimension of the Index

In current products, most index selection is arbitrary and single. Rice drought index-based insurance, for example, most products only use precipitation as the sole evaluation index. When the precipitation is below the specified threshold, compensation will be made according to the missing rainfall per millimeter of each insurance unit. This simple design not only increases the demand for data quality but also ignores the crop's own disaster sensitivity at different growth stages, which brings great basic risk. Similarly, in some grassland insurance products, vegetation index is the only index used to evaluate the growth status of crops. Few products use multiple indicators to build a composite index for evaluation, and fewer products are designed with different types of indicators (meteorology, remote sensing, crop growth characteristics, etc.). Therefore, the index-based insurance urgently needs a composite index that includes multidimensional indexes and can reflect crop disaster threat sensitively.

(3) The Difficulty of Designing Products Automatically

The core content of index-based agricultural insurance design is to quantify the loss rate of crops against the selected index. Therefore, designing identical products for different risk zone is a systematic project with a large workload. It not only needs to process a large number of meteorological, remote sensing, and agricultural data but also to test and analyze the designed products. At present, there is no such index-based agricultural insurance product.

Therefore, new technical methods are needed to scientifically and rationally design agricultural insurance products and determine their insurance premium rates in order to at least partially solve the problems existing in the prior art.

### SUMMARY

The invention provides a framework for scientifically designing index-based agricultural insurance products based on meteorology, remote sensing, crop growth model and numerical simulation.

According to an aspect of the invention, a method for designing a composite-index agricultural insurance product is provided, including the following steps:
S1: Obtaining the required data in the study area, including meteorological data, soil data, field trial data, remote sensing data, and disaster statistics data;
S2: Determining disaster-free years, disaster years, and disaster events in disaster years according to meteorological data and disaster statistics data, generating the ideal climatic scenario as a benchmark by using the mean values of meteorological data during disasters-free years, and building climatic scenarios under disaster by using the Monte Carlo method based on the ideal climatic scenario;
S3: Calibrating the site-level crop growth model by using the field trial data, then inputting the ideal climatic scenario and the climatic scenarios under disaster of S2 into the calibrated crop growth model to get the corresponding output data, and calculating the yield loss rates (Yₗₒₛₛ) of each scenario in each site according to the following Eq.:

$${Y}_{loss , k} = \frac{{Y}_{d , k} - {Y}_{i}}{{Y}_{i}} \times 100 \%$$

where Y_{c,k} is the yield under disaster scenario k, Yᵢ is the yield under the ideal scenario, and Y_{loss,k} is the corresponding yield loss rate under disaster scenario k;
S4: Based on the distribution of the yield loss rates, determining the premium rates of agricultural insurance, in which the net rate (μ) is calculated according to the following Eq.:

μ=E[LCR]=E[Yₗₒₛₛ]

where LCR is the loss cost ratio (%), and E[ . . . ] represents the process of averaging;
S5: choosing several candidate indicators to characterize the disaster, and calculating the correlation coefficients between each indicator and simulated Yₗₒₛₛ based on the climatic scenarios under disaster and the output data, and based on the magnitude of the correlation, selecting 4 to 6 strong correlation indicators to form a composite index (CI).
S6: Building a vulnerability model that reflects the response between the yield loss rate and the composite index by using the composite index and the yield loss rate of the climatic scenarios under disaster, and using the vulnerability model to predict the yield loss due to disaster in a specific period and space and determine whether or not making a payout, if making a payout, the amount of payout is calculated based on the premium rate.

According to the embodiment of this invention, the correlation coefficients in step S5 are calculated by a common statistic software—SPSS Statistics.

According to the embodiment of this invention, the crop model is selected from the DSSAT series models (American), the CCSODS series models (Chinese), and the APSIM series models (Australian).

According to the embodiment of this invention, wherein the premium rate in step S4 includes the risk loading rate (LOAD_{RP}), which is calculated as follows:

LOAD_{RP}=LCR_{RP}−μ

wherein the LCR_{RP} is the loss cost ratio for a specific return period.

According to the embodiment of this invention, the insured crop can be maize, rice, wheat, or soybean.

According to the embodiment of this invention, wherein the composite-index agricultural insurance product is designed for chilling injury, a year in which there is no statistical record of disasters during crop growth period and the absolute value of Anomaly of Growing Degree Days (AGDD) is less than 50 is defined as a disaster-free year a year in which there is a statistical record of disasters during crop growth period or the Anomaly of Growing Degree Days (AGDD) is less than −50 is defined as a disaster year; and for each disaster year, a day in which the lowest temperature is less than the low threshold temperature for crop growing is defined as one disaster event, that is, one chilling event.

According to the embodiment of this invention, wherein the candidate indicators include the Anomaly of Growing Degree Days (AGDD), Chilling Growing Degree Days (CGDD), the number of days with Tₘᵢₙ Below 2° C. (TB2), and the Anomaly of maximum Leaf Area Index (ALAI).

According to the embodiment of this invention, wherein the composite-index agricultural insurance product is designed for drought; a year in which there is no statistical record of disasters during crop growth period and the Standardized Precipitation Index (SPI) is more than −1 is defined as a disaster-free year; a year in which there is a statistical record of disasters during crop growth period or the Standardized Precipitation Index (SPI) is no more than −1 is defined as a disaster year; and for each disaster year, the case that the number of continuous no-rain days is more than 3 is defined as one disaster event, that is, one drought event.

According to the embodiment of this invention, the candidate indicators include the Standardized Precipitation Index (SP/), the Standardized Soil Moisture Index (SSMI), and Relative Leaf Area Index (RLAI).

According to the embodiment of this invention, wherein in step S6, building the vulnerability model includes utilizing a “curve estimation” module in statistical analysis software SPSS and using the maximum average determination coefficient (R²).

According to the embodiment of this invention, wherein step S2 includes constructing a site-level disaster event frequency and intensity distribution function based on frequency and intensity of the disaster events, and using the distribution function to obtain various simulated disaster scenarios for each site.

According to the embodiment of this invention, wherein in step S6, according to the vulnerability model, when the predicted yield loss rate (Yₗₒₛₛ) is greater than a predetermined value, it is confirmed that a catastrophic crop failure occurs and the payout is made; when the predicted Yₗₒₛₛ is no more than the predetermined value, no payout is made.

According to the embodiment of this invention, wherein the predetermined value is about 4%.

According to another aspect of the invention, an index-based disaster agricultural insurance product is provided, which is designed and obtained according to the method of the invention.

Compared with existing technical methods, this invention has many advantages:

This technology has a standard and transparent technical process, which can automatically realize the product design in different risk areas, saving a lot of time, labor, money, and cost. The invention establishes the composite index by the multi-source indicators, improving the evaluation dimension of the index-based insurance, and solving the problem of balancing its inherent simplicity and analytical. The invention also uses the crop model with a strong mechanism to complete the simulation of chilling injury loss, which makes up for the defect of poor loss data quality in agricultural insurance. Moreover, the invention also provides technical support for insurance companies to accurately predict the yield loss before crop harvesting. It provides an important scientific basis for index agricultural insurance research, helping insurance companies and relevant state departments to complete product design and promotion more quickly. In addition, it is also helpful for relevant departments to make accurate decisions on grain situation judgment, grain regulation, and grain trade even provides new scientific decision-making ideas for national and global index-based agricultural insurance product design.

### BRIEF DESCRIPTION OF THE DRAWINGS

The same figure marks in the figure indicate the same or similar unit or part. The objectives and characteristics of the invention are more apparent considering the following description combined with the figures.

FIG. 1 is the flowchart of the method for determining the premium rates of index-based agricultural insurance products according to an embodiment of the invention.

FIG. 2 is the research area according to an embodiment of the invention.

FIG. 3 is the result of the vulnerability model of each site according to an embodiment of the invention.

### DETAILED DESCRIPTION

In order to clearly illustrate the present invention, preferred example is given below and illustrated in detail combined with the figure. The following specifications are merely exemplary and are not intended to limit the application.

It should be understood that the crop model, remote sensing module and simulation technology themselves referred to in the invention are known in the art, such as each sub-module of the model, various parameters, operating mechanisms, etc. Therefore, the invention focuses on how to integrate the simulation technology, remote sensing data and crop model together to design index-based insurance products.

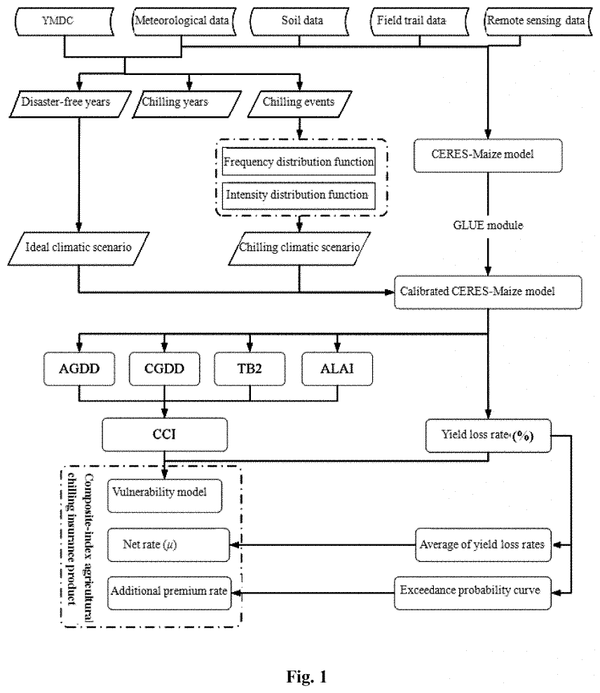

FIG. 1 is a flowchart of the method for determining the premium rates of index-based agricultural insurance products according to an embodiment of the invention. The embodiment is illustrated with maize and chilling injury as examples.

As shown in the figure, the insurance rate determination method for the index-based agricultural insurance product of the invention may include the following steps:
S1: Obtaining the required data in the study area, including the meteorological data, soil data, field trial data, remote sensing data, and disaster statistics data (from the Yearbook of Meteorological Disasters in China).

FIG. 1 takes chilling injury as an example, however, it should be understood that the invention can also be applied to other disasters such as drought, flood, heat damage, and so on. Therefore, the index-based agricultural insurance products of the invention can be designed for such as the chilling-index, drought-index, flood-index, and heat damage-index products.

FIG. 1 takes maize as an example, and the crop model adopted is CERES-Maize in the DSSAT (Decision Support System for Agrotechnology Transfer) series models. DSSAT is an integrated computer model developed by the agricultural technology transfer International reference network IBSNAT project, Florida state university, Georgia state university, Hawaii state university, Michigan state university, and other international research institutes organized by USDA, its purpose is to accelerate agricultural model technology promotion and to provide decision-making for the rational and efficient use of agricultural and natural resources. At present, it has been successfully and widely used in a number of crop growth simulation studies around the world with good performance.

It should be understood that the invention can also be applied to other crops such as rice, wheat, and soybean. In other words, the crop model can be selected from other series models in the DSSAT series models (American), the CCSODS series models (Chinese), and the APSIM series models (Australian), etc.

Meteorological data may include daily maximum air temperature, minimum air temperature, solar radiation, and precipitation. Soil data may include soil type, soil organic carbon content, soil total nitrogen content, soil permeability, field water capacity, etc. Field trial data may include crop variety information, yield per unit area data, key growth period data, etc. Remote sensing data can adopt GLASS (Global Land Surface Satellite) LAI (leaf area index) product (Liang shunlin et al. Beijing Normal University), an improvement on MODIS LAI product, which has been widely accepted as for its better spatial completion and temporal continuity. The disaster statistics data may include disaster location, time, damage extent, disaster area, etc.
S2: According to meteorological data and disaster statistics data, the disaster-free years, disaster years, and disaster events in disaster years were calibrated. Here, the ideal climatic scenario was generated as a benchmark by the mean values of meteorological data during disasters-free years, and the climatic scenarios under disaster were built by the Monte Carlo method that randomly adds disaster events into the ideal scenario.

Taking maize chilling injury as an example, the calibration of disaster-free years and chilling years mainly relies on the records in the disaster statistical yearbook, and is supplemented by the Anomaly value (AGDD, Eq. 2) of Growing Degree Days (GDD, Eq. 1),

$$G D D = {\sum }_{May .}^{Sep .} ( \frac{{T}_{max} + {T}_{min}}{2} - 10 ) \qquad ( 1 )$$

where GDD is defined as the sum of the difference between the daily average temperature and 10° C. during the whole growth period; Tₘₐₓ and Tₘᵢₙ represent respectively the maximum temperature and minimum temperature for each day; mean(GDD) represents the mean GDD of the past previous thirty years. Notably, when the daily average temperature is lower than 10° C. or higher than 30° C., we will skip this day without calculation.

AGDD=GDD−mean(GDD) (2)

where, AGDD is the difference between the annual GDD and the average GDD of the past 30 years which is represented by mean(GDD).

The disaster-free year and chilling year are calibrated or determined by the following standards: Disaster-free year: There is no disaster record in the Yearbook of Meteorological Disasters in China during the maize growth period of this year (May to September), and the absolute value of AGDD was less than 50. Chilling year: There is at least one chilling record in the Yearbook of Meteorological Disasters in China during the maize growth period of this year, or the value of AGDD was less than −50.

For each chilling year, we labeled the day in which the lowest temperature was lower than the low threshold temperature for maize growing as a chilling event, and record the corresponding weather data and the frequency of occurrence of chilling events during each growth period (a total of 5 growth periods, respectively seeding—emergence, emergence—jointing, jointing—flowering, flowering—heading, heading—maturity). Minimum temperatures for crops such as maize can be obtained based on prior technology, for example, minimum temperatures for the five growth s periods of maize can be 8° C., 12° C., 16° C., 14° C. and 12° C., respectively.

The simulation scenario can be established based on Monte Carlo simulation technology, which can include the following steps:

\textcircled{1} The weather data (temperature, precipitation and radiation) of all disaster-free years were averaged, and then the outliers were removed according to the general knowledge of the field, it is then used as an ideal scenario for each site in the simulation process.

\textcircled{2} Summarizing the frequency and intensity of chilling events in each growth period of maize, and then performing the probability distribution fitting and chi-square fitting goodness test. For the distribution function that has passed the test, the root mean square error (RMSE, Eq. 3) can be used as the standard to obtain the distribution function of frequency and intensity of chilling events at each station.

$$R M S E = \sqrt{{\sum }_{I = 1}^{n} \frac{{( {Y}_{i} - {X}_{i} )}^{2}}{n}} \qquad ( 3 )$$

where, RMSE is defined as the deviation between the observed value and the truth value, n is the number of observations, Y; is the truth value, and Xi is the observed value.

\textcircled{3} According to the distribution function in \textcircled{2}, generating the random chilling event in consistent with its probability distribution law, and adding it to the ideal scenario (replace the temperature data in the ideal scenario), getting a variety of chilling disaster scenarios for each station, such as 200, 300, 400.

Similarly, in the case of wheat drought, the year can be designated as a disaster-free year when there is no statistical record of disasters during crop growth and the standardized precipitation index (SPI) is more than −1. The year can be designated as a disaster year if there is statistical record of disasters during the crop growth period, or if the SPI is no more than −1. For each disaster year, a drought event is marked by more than three (for example, 4-6 days) consecutive days of no rainfall recorded during the growth periods. The growth periods of different crops are known, for example, the growth periods of wheat can be divided into three stages, namely Emergence-Greenup, Greenup-Heading, and Heading-Mature.

SPI is used to monitor surface drought, which can be calculated based on rainfall data of various drought scenarios. The calculation can be based on the Taesam Lee SPI calculation program provided on MatWorks® (2009 https://www.mathworks.com/matlabcentral/fileexchange/26018-standardized-precipit ation-index). According to the world meteorological organization, the time scale of SPI from March to June is more suitable for monitoring agricultural drought. Therefore, three months can be selected as the time scale to calculate the SPI index based on the rainfall data set of stations (sites) and obtain the SPI data set of drought scenarios.

S3: Calibrating the site-level crop growth model by the field trial data, then entering the simulation scenarios of S2 into the calibrated model to get the corresponding output data. The data include yield Y and yield loss rate Yₗₒₛₛ, the yield loss rates (Yₗₒₛₛ) of each scenario in each site is calculated as follows:

$${Y}_{l o s s , k} = \frac{{Y}_{d , k} - {Y}_{i}}{{Y}_{i}} \times 100 \% \qquad ( 5 )$$

wherein Y_{c,k} is the yield (kg/ha) under disaster scenario k, Y is the yield (kg/ha) under the ideal scenario, and Y_{loss,k} is the corresponding yield loss (%) under disaster scenario k.

Calibration in S3 can be done based on the combination of “GLUE”, a planning tool built into the DSSAT model, and “trial and error”, which can mainly calibrate the flowering date, maturity date and yield per unit area of each species. Similarly, these three output variables can also be used as validation indicators of the model, and the performance of the model can be evaluated by solving the standard root mean square error (NRMSE, Eq. 4). In general, the simulation can be considered excellent if the NRMSE is less than 10%; the simulation is considered good if the NRMSE is between 10 and 20%; the simulation can be considered poor if the NRMSE is greater than or equal to 20%.

$$NRMSE = \frac{R M S E}{\overline{Y}} \times 100 \% \qquad ( 4 )$$

wherein NRMSE is the statistical value obtained after regularization of RMSE, Y̅ is the average of the truth values

Take chilling damage as an example, the yield difference between the chilling injury scenario in step S3 and the corresponding ideal scenario can be regarded as the yield t loss caused by a single factor of chilling injury. In order to facilitate the comparison and analysis among stations, the yield loss can be expressed as the yield loss rate (Yₗₒₛₛ, Eq. 5) in the following steps:

$${Y}_{l o s s , k} = \frac{{Y}_{d , k} - {Y}_{i}}{{Y}_{i}} \times 100 \% \qquad ( 5 )$$

S4: Based on the distribution of Yₗₒₛₛ, the premium rates of composite-index agricultural insurance were determined, in which the net rate (μ) and risk loading rate (LOAD_{RP}) can be calculated as follows:

$$\begin{matrix}μ = E [ L C R ] = E [ {Y}_{loss} ] & ( 14 ) \\ {LOAD}_{R P} = L C {R}_{R P} - μ & ( 16 ) \\ LCR = \frac{Actual compensation}{Maximum compensation} = \frac{{Y}_{g} \times p}{Y \times p} = {Y}_{loss} & ( 13 )\end{matrix}$$

where Yg refers to the yield loss (kg/ha) caused by disaster; Y is the total (or maximum) yield (kg/ha) of the insurance coverage area; p is the compensation per kilogram (RMB/kg), LCR is the loss cost ratio (%), and E[ . . . ] represents the process of averaging. The LCR_{RP} is the loss cost ratio in a specific return period; RP represents the return period of an event, and LOAD_{RP} is the difference between LCR_{RP} and μ.

Premium is an essential part of an insurance product, which is generally the product of insurance amount and premium rate. However, the insurers will impose additional premiums other than the μ to prevent the risk of over-compensation. For this additional rate, the invention only focused on the LOAD_{RP}, caused by meteorological reasons, but ignored the additional administrative loading that varies by insurers. In step S6, the p was calculated from the mean Yₗₒₛₛ for a variety of simulated scenarios (for example, 300), while the LOAD_{RP} was calculated from the exceedance probability (EP) curve, which indicated the probability that a given Yₗₒₛₛ will be equaled or exceeded. By the EP curves, for example, the yield loss rate corresponding to major disasters that occur once in 50 years and once in 100 years can be calculated.

Further, it can be seen from the above definitions that the μ is usually equal to E[LCR], and μ is also equal to Yₗₒₛₛ.

$$L C {R}_{R P} = arg \{ \text{X:Pr} \{ x > X \} = \frac{1}{R P} \} \qquad ( 15 )$$

where RP represents the return period of an event, such as RP=50 means a once-in-a-half-century event; Pr is the probability of an event happening; x is the variable which refers to the loss of a disaster; X is the specific disaster losses. The LCR_{RP} is the loss cost ratio in a specific return period.
S5: The several candidate indicators were first chosen to characterize the disaster, then the correlation between each indicator and simulated Yₗₒₛₛ were calculated. Depending on the magnitude of the correlation, there are 4 to 6 strong correlation indicators selected and integrated into an un-weighted composite index (CI).

For example, as for maize, there are 8 commonly used indicators of the maize chilling injury, including seven meteorological indicators: Anomaly of Growing Degree Days (AGDD, Eq. 2), Chilling Growing Degree Days in 5 growth stages (CGDD₁-CGDD₅, Eq. 6), and the number of days with Tₘᵢₙ Below 2° C. (TB2, Eq. 7); and a remote sensing index: the Anomaly of maximum Leaf Area Index (ALAI, Eq. 8):

$$\begin{matrix}C G D {D}_{n , k} = {\sum }_{s t a r {t}_{n}}^{e n {d}_{n}} ( {T}_{min} - L {T}_{n} ) , n = 1 , 2 , 3 , 4 , 5 & ( 6 ) \\ TB2 = \{ \begin{matrix}+ 1 , {T}_{min} < {2}^{∘} C . \\ + 0 , {T}_{min} \geq {2}^{∘} C .\end{matrix} & ( 7 )\end{matrix}$$

where LTₙ and Tₘᵢₙ represents the low-temperature threshold for the n stage and the daily minimum temperature, respectively. When Tₘᵢₙ is higher than the corresponding LTₙ, we will skip this day without calculation. When the daily minimum temperature during the growth period is lower than 2° C., the number of TB2 is increased by one.

ALAI_{max,y}=LAI_{max,y}−mean(LAIₘₐₓ) (8)

where LAI_{max,y} is the maximum LAI in y year; mean(LAIₘₐₓ) is the average maximum LAI over the years (from 2000 to 2015).

In addition, the correlation between each candidate indicator and yield loss can be calculated by a common statistic software—IBM SPSS Statistics. For example, the present embodiment adopts Pearson correlation coefficient (Pearson's r) and set 0.2 as threshold, then exclude the indicators which the |Pearson's r|<0.2. The final composite index (CI), that is, composite chilling index (CCI, Eq. 9) is only based on the top 4-6 (such as 5) indicators which have been identified to occur most frequently among 16 studied sites.

$$C C I = \frac{\begin{matrix}{Indicator}_{1} + {I ndicator}_{2} + {Indicator}_{3} + \\ {Indicator}_{4} + {I ndicator}_{5}\end{matrix}}{5} \qquad ( 9 )$$

where indicator₁˜indicator₅ represent the final chosen indicators, which respectively represent the top five indicators with the highest frequency from each site(station); the final chosen indicators can be normalized by such as Min-Max scaling, and then these normalized indicators are added together without weight, and their average can be used as a composite (chilling) index, or the weighted average mean of these normalized indicators can be used as a composite (chilling) index, and the weighting factor can be based on their respective correlation.

Similarly, the drought disasters of wheat can use three kinds of candidate indicators: Standardized Precipitation Index (SPI, see in step S2), the Standardized Soil Moisture Index (SSMI, Eq. 10), and Relative Leaf Area Index (RLAI, Eq. 1). Moreover, there are two different depth for SSMI can be select, 20 cm and 50 cm.

$$SSMI = \frac{SM - \overline{SM}}{σ} \qquad ( 10 )$$

where SM is the soil moisture value in a certain time scale, S̅M̅ is the average soil moisture over the years in this time scale, and σ is the standard deviation of soil moisture over the years in this time scale.

$$R L A I = \frac{LAI}{max ( LAI )} \qquad ( 11 )$$

where RLAI is the relative value of acquired LAI, and max(LAI) is the maximum LAI in the whole growth period.

These three kinds of indicators can be divided into 16 indicators according to 4 periods: P1 (Emergence-Greenup), P2 (Greenup-Heading), P3 (Heading-Mature), and P4 (the whole growth period), so there are 16 indicators: SPI_P1, SPI_P2, SPI_P3, SPI_P4, SSMI_20 cm_P1, SSMI_20 cm_P2, SSMI_20 cm_P3, SSMI_20 cm_P4, SSMI_50 cm_P1, SSMI_50 cm_P2, SSMI_50 cm_P3, SSMI_50 cm_P4, RLAI_P1, RLAI_P2, RLAI_P3, RLAI_P4.
S6: Combining CI with Yₗₒₛₛ, the vulnerability model was built that can quantitatively predict the yield loss due to disaster in a specific period and space. using the vulnerability model to predict the yield loss and determine whether or not making a payout, if making a payout, the amount of payout is calculated based on the premium rate of step S4.

The vulnerability model can be built based on a “curve estimation” module in statistical analysis software SPSS and using the one with maximum average determination coefficient (R², Eq. 12) as the final vulnerability model.

$${R}^{2} = \frac{S S R}{S S T} = \frac{{{Σ}_{i = 1}^{n} ( {\hat{y}}_{1} - \overline{y} )}^{2}}{{{Σ}_{i = 1}^{n} ( {y}_{i} - \overline{y} )}^{2}} \qquad ( 12 )$$

where R² is the ratio of regression sum of squares and total sum of squares of dispersion, [symbol] represents the true value, y_{I} is the observed value, y̅ is the mean of the observed value. It is the proportion of the total sum of squares that can be explained by the regression sum of squares, the larger the ratio, the better, the more accurate the model, the more significant the regression effect. Generally, the closer R² is to 1, the better the regression fit, and it is believed that models with R² over 0.8 have a better fit.

The vulnerability model is based on the composite index and the loss of crop model output, which can reflect the response a universal “index-loss” relationship for the certain region over many years. When the disaster occurred, the vulnerability model can be used to predict losses and calculate compensation, without relying on the field investigation.

### EXAMPLES

We took the maize chilling injury in Northeast China (NEC) as an example to illustrate the technical method of the present invention. The embodiment is for illustrating the present invention, but not to limit the scope of the present invention.

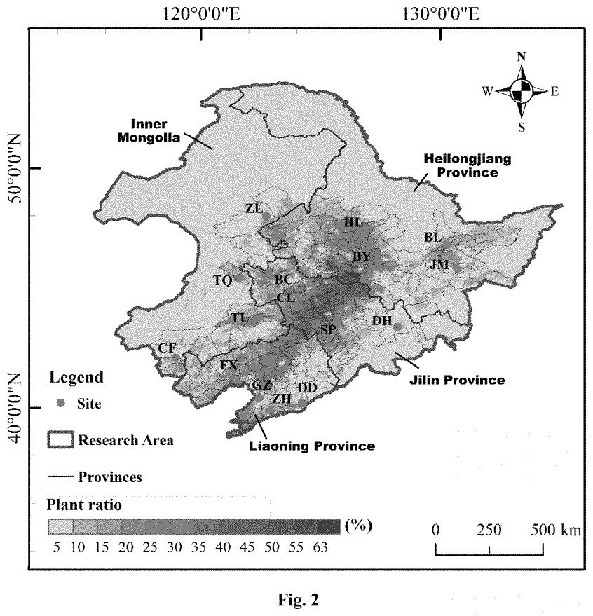

Due to the high latitude and frequent extreme events, NEC is highly vulnerable to climate change (FIG. 2) and has become one of the areas with the highest yield fluctuations in China. Here, the growth period of spring maize here is generally from early May to the end of September. Based on the Spatial Production Allocation Model Global Data (SPAM), and combined county-level statistic data in 2000, 2005, and 2010, the embodiment selected 188 counties with maize harvest area larger than 3% as the studied areas. Among them, 16 experimental sites(station) with good data and good representative ability were selected in particular as the main research objects: Baicheng (BC), Bayan (BY), Boli (BL), Changling (CL), Chifeng (CF), Dandong (DD), Dunhua (DH), Fuxin (FX), Gaizhou (GA), Hailun (HL), Jiamusi (JM), Siping (SP), Tongliao (TL), Tuquan (TQ), Zhalantun (ZL), Zhuanghe (ZH).

Five datasets were used in this embodiment as follows: 1) The daily climate dataset (1951˜2015) at 75 meteorological stations in NE, including maximum temperature (Tₘₐₓ), minimum temperature (Tₘᵢₙ), precipitation, and sunshine duration, which is from the China Meteorological Administration (CMA) climate data-sharing service system; 2) The soil dataset from a global high-resolution soil profile database, including soil type, soil organic carbon content, soil total nitrogen content, soil permeability, field water capacity, etc; 3) The field trial dataset (2010˜2012, CMA) at 16 agrometeorological experimental stations, including crop phenology records, variety, management practices, and yield; 4) The leaf area index (LAI) dataset (2000˜2015) from Global Land Surface Satellite (GLASS) project, with the resolutions of 8 days and 1 km×1 km; 5) The recorded chilling events from Yearbook of Meteorological Disasters in China (YMDC, 1991˜2012).

In general, data 1) to 3) may be used to drive, calibrate and validate the crop growth model (localization); data 1) and 5) may be used to build simulation scenarios; data 1) and 4) may be used to build composite index and calculate insurance rates.

Chilling injury can impose destructive impacts on plant life, and its consequent yield loss is generally recorded in the Yearbook of Meteorological Disasters in China (YMDC). Unfortunately, these official records often have glaring inaccuracies or omissions. To supplement and correct the records in YMDC, the invitation defined the chilling year as far as it met one of the following criteria: 1) the Anomaly of Growing Degree Days (AGDD)<−50° C.d; 2) there is at least one recorded chilling event in growing seasons in YMDC. For each chilling year, the chilling events were also found out by average temperature lower than the corresponding low threshold.

Based on these chilling data, we then used Monte Carlo technology to generate hundreds of scenarios. For each site, 301 climatic scenarios were set, including one ideal scenario and 300 chilling scenarios. The ideal climatic scenario was generated as a benchmark by the mean values of meteorological data during disasters-free years, then 300 chilling climatic scenarios at each station were built by randomly adding chilling events into the ideal scenario. Notably, each added event was generated based on the frequency and intensity distribution of chilling events, which were under Exponential distribution and Gamma distribution, respectively (both distributions passed the chi-square test at a significance level of 0.01).

The embodiment selected the CERES-Maize, within the Decision Support System for Agrotechnology Transfer (DSSAT v4.7), to effectively expand losses data. The model is a comprehensively process-level model at a daily time step. Based on physiological processes modeling crop responses to soil and weather conditions, the CERES-Maize could simulate crop growth, development, and final grain yield. In the embodiment, calibration is based on the Generalized Likelihood Uncertainty Estimation module (GLUE) included in DSSAT. During the calibration process, yield at harvest maturity (HWAM), anthesis date (ADAT), the physiological maturity date (MDAT), and other management activities (e.g., fertilization and irrigation) were used as reference information. Meanwhile, we selected the root mean square error (RMSE) and normalized root mean square error (NRMSE) to assess the performance of the model.

Table 1 shows the calibration results of the CERES-Maize model, in which the simulated values of anthesis date (ADAT), the physiological maturity date (MDAT), and yield at harvest maturity were compared with their observations. The ADAT (NRMSE 4.19%) was calibrated better than the others, e.g., NRMSEs of MDAT are less than 9.67%, and have about 7% span. For the yield, NRMSE is no more than 10%. The average RMSEs of ADAT, MDAT, and yield in 16 sites are less than 3 days, 9 days and 688.39 kg/ha, respectively. The performance of the calibrated CERES-Maize across different provinces has no significant disparity. The most accurate Liaoning has an average 602 kg/ha error in the yield simulation, while the average RMSE of yield in Heilongjiang (worst) is 735 kg/ha. According to the criteria of model calibration, the calibrated CERES-Maize model indicated an “excellent” performance (NRMSE<10%), which can accurately simulate the maize growth states and the final yield at each site.

TABLE 1
Model validations results for the CERES-Maize model at each site

| | | ADAT (day) | | MDAT (day) | | Yield (kg/ha) | |
|---|---|---|---|---|---|---|---|
| Province | Site | RMSE | NRMSE | RMSE | NRMSE | RMSE | NRMSE |
| Heilongjiang | Bayan | 2.16 | 2.83% | 9.81 | 7.36% | 526.60 | 5.16% |
| | Boli | 1.73 | 2.24% | 11.47 | 8.26% | 453.92 | 6.01% |
| | Hailun | 2.65 | 3.50% | 9.75 | 6.85% | 793.85 | 9.91% |
| | Jiamusi | 4.83 | 8.01% | 12.01 | 7.82% | 1165.73 | 8.86% |
| Jilin | Baicheng | 1.83 | 2.45% | 13.44 | 9.67% | 674.52 | 5.62% |
| | Changling | 1.29 | 1.57% | 5.92 | 4.23% | 412.90 | 2.81% |
| | Dunhua | 4.90 | 6.68% | 11.82 | 9.26% | 545.45 | 6.65% |
| | Siping | 2.16 | 2.71% | 3.83 | 2.61% | 822.58 | 6.00% |
| Liaoning | Dandong | 2.65 | 3.14% | 4.51 | 3.12% | 873.56 | 6.43% |
| | Fuxin | 3.46 | 4.31% | 5.72 | 4.05% | 616.41 | 6.29% |
| | Gaizhou | 1.83 | 2.74% | 10.34 | 8.17% | 295.20 | 3.28% |
| | Zhuanghe | 2.16 | 2.50% | 3.42 | 2.40% | 623.30 | 8.32% |
| Inner | Chifeng | 4.65 | 6.07% | 8.33 | 5.33% | 1067.79 | 8.38% |
| Mongolia | Tongliao | 2.38 | 2.93% | 10.10 | 7.28% | 502.04 | 3.94% |
| | Tuquan | 5.29 | 6.67% | 7.05 | 6.08% | 536.20 | 8.39% |
| | Zhalantun | 3.11 | 4.62% | 8.08 | 6.61% | 459.83 | 6.21% |
| Average | | 3.20 | 4.19% | 9.00 | 6.52% | 688.39 | 6.61% |

*ADAT means anthesis date, MDAT means physiological maturity date

Most previous studies only used a single weather-related indicator to analyze chilling injury for the whole growing season but ignored some decisive limitations, such as the difference in crop sensitivity during growth period or sudden extreme chilling events. Here, we used Anomaly of Growing Degree Days (AGDD), Chilling Growing Degree Days (CGDD), the number of days with Tₘᵢₙ Below ° C. (TB2) to characterize the relationship between chilling and crop growth in different aspects, and the Anomaly of maximum Leaf Area Index (ALAI) to represent the crop growth levels.

Based on the output data of 300 chilling scenarios at each site, we analyzed the correlation between each indicator and Yₗₒₛₛ. Table 2 summarizes the initial selections in each site. Among eight indicators (AGDD, CGDD₁˜CGDD₅, TB2, and ALAIₘₐₓ), only four to six indexes have satisfied the condition of |Pearson's r|≥0.2. Notably, AGDD, ALAIₘₐₓ, and CGDD₅ are consistently listed for all sites, followed by TB2 (12 sites) CGDD₄ (11 sites), CGDD₃ (6 sites), CGDD₂ (3 sites) and CGDD₁ (2 sites). Therefore, CCI is finally determined by the top 5 normalized indicators according to Eq. 17(un-weighted):

CCI=(AGDD+CGDD_5+CGDD_4+TB2+ALAI)/5 (17)

TABLE 2
List of initially selected indicators for yield-correlated indexes at each site

| Province | Site | Selected Indicators (Sort by correlation) |
|---|---|---|
| Heilongjiang | Bayan | AGDD, ALAIₘₐₓ, CGDD₅, CGDD₄, TB2 |
| | Boli | AGDD, ALAIₘₐₓ, CGDD₅, CGDD₄, CGDD₁, TB2 |
| | Hailun | AGDD, CGDD₃, ALAIₘₐₓ, CGDD₄, CGDD₅, TB2 |
| | Jiamusi | CGDD₅, CGDD₃, AGDD, TB2, ALAIₘₐₓ |
| Jilin | Baicheng | AGDD, ALAIₘₐₓ, CGDD₅, CGDD₁, TB2 |
| | Changling | ALAI_{max,} CGDD₃, CGDD₅, AGDD, CGDD₄, TB2 |
| | Dunhua | CGDD₅, AGDD, ALAIₘₐₓ, TB2, CGDD₃ |
| | Siping | ALAIₘₐₓ, CGDD₅, AGDD, TB2 |
| Liaonin | Dandong | CGDD₄, AGDD, ALAIₘₐₓ, CGDD₅, TB2 |
| | Fuxin | ALAIₘₐₓ, AGDD, CGDD₅, CGDD₄ |
| | Gaizhou | CGDD₄, CGDD₅, AGDD, ALAIₘₐₓ, CGDD₃ |
| | Zhuanghe | CGDD₅, AGDD, ALAIₘₐₓ, TB2 |
| Inner | Chifeng | CGDD₄, AGDD, CGDD₃, CGDD₅, ALAIₘₐₓ |
| Mongolia | Tongliao | CGDD₄, AGDD, CGDD₃, ALAIₘₐₓ, CGDD₅, TB2 |
| | Tuquan | CGDD₅, ALAIₘₐₓ, AGDD, CGDD₄ |
| | Zhalantun | AGDD, ALAIₘₐₓ, CGDD₅, CGDD₄, TB2 |

* all indicators have passed chi-square tests at the level of 0.01, and their Pearson's r is larger than 0.2

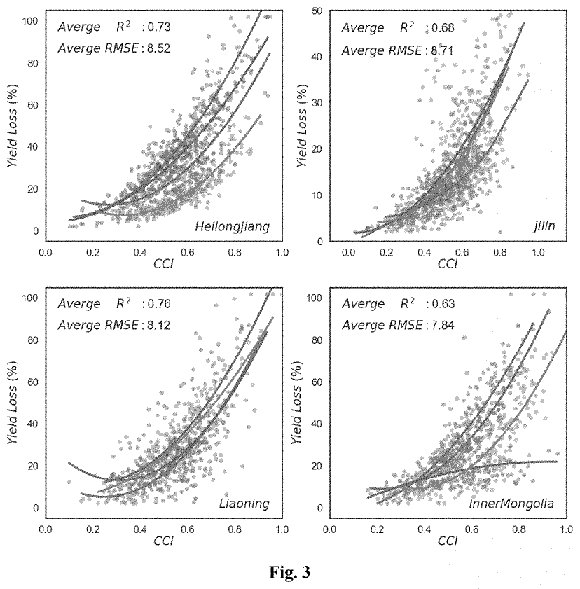

To find a generic and suitable model that could fit for Yₗₒₛₛ-CCI relationship at each site, seven statistic models were chosen as candidates (linear, logarithmic, inverse, quadratic, cubic, power, and exponential) in the Curve Estimation module of a common statistic software—IBM SPSS. Then, they were compared based on the coefficient of determination (R²), and the model with maximum average R² (among 16 sites) was set as the final vulnerability model. In order to further evaluate this vulnerability model, we verified them through the actual loss records in the YMDC from 2000 to 2015. This verification is done at the site level, and we plotted the site-level vulnerability models in each province (FIG. 3), which indicated that maize yield losses had good quadratic relationships with chilling stresses. In general, the vulnerability models showed comparable ability to estimate yield loss but performed more easily, which exactly met the requirements for designing insurance products.

To cover overpays due to extreme chilling events, we calculated the risk loading rate (LOAD_{RP}) in the return period of 50 and 100 years, and the net (premium) rate (μ) (see Table 3). The results also show that the commonly used “one province, one rate” insurance is rough and irrational, and accurate index-based insurance is the future direction of agricultural insurance.

TABLE 3
the risk loading rate (LOAD_{RP}) and the net rate (μ) for each site (%)

| | | | LCR_{RP} | |
|---|---|---|---|---|
| Province | Site | μ | 1/50a | 1/100a |
| Heilongjiang | Bayan | 4.85 (4.44, 5.38) | 21.93 (20.21, 24.00) | 26.44 (24.12, 27.77) |
| | Boli | 5.78 (5.22, 6.30) | 23.91 (21.75, 26.26) | 29.71 (26.54, 31.76) |
| | Hailun | 4.05 (3.73, 4.44) | 18.81 (17.03, 20.73) | 22.93 (20.97, 24.85) |
| | Jianiusi | 2.77 (2.57, 3.03) | 14.54 (13.21, 15.73) | 17.10 (15.84, 18.40) |
| Jilin | Baicheng | 3.76 (3.46, 4.07) | 16.99 (15.65, 18.62) | 20.18 (18.86, 21.56) |
| | Changling | 4.93 (4.42, 5.44) | 22.57 (20.25, 25.02) | 26.77 (24.62, 29.34) |
| | Dunhua | 4.98 (4.62, 5.61) | 23.49 (20.70, 25.20) | 28.45 (25.21, 31.23) |
| | Siping | 4.73 (4.46, 5.06) | 22.56 (21.11, 23.83) | 27.09 (25.48, 29.05) |
| Liaoning | Dandong | 3.88 (3.62, 4.24) | 17.71 (16.28, 19.13) | 21.86 (19.98, 24.75) |
| | Fuxin | 4.04 (3.74, 4.39) | 18.06 (16.48, 19.64) | 21.28 (19.62, 23.15) |
| | Gaizhou | 3.45 (3.24, 3.66) | 16.01 (14.84, 17.14) | 19.02 (17.85, 20.78) |
| | Zhuanghe | 4.57 (4.15, 4.98) | 21.51 (18.99, 23.44) | 25.87 (24.21, 28.23) |
| Inner | Chifeng | 4.47 (4.11, 4.84) | 20.53 (18.91, 22.69) | 25.00 (23.16, 27.30) |
| Mongolia | Tongliao | 4.31 (3.87, 4.72) | 19.24 (17.50, 21.87) | 23.87 (21.79, 25.87) |
| | Tuquan | 3.57 (3.37, 3.85) | 17.18 (15.88, 18.75) | 21.61 (19.51, 23.59) |
| | Zhalantun | 4.87 (4.48, 5.44) | 20.67 (18.43, 22.61) | 25.10 (21.94, 27.21) |

*The numbers in parentheses represent 95% confidence interval

The embodiment further designed the maize composite-index-based insurance using the one-year county-level CICCI, which was based on the final grain yield (kg/ha). The insurance contract should be signed before the planting date of spring maize in the study area, and the insurers could forecast the compensation according to the vulnerability models as the threshold of index-based insurance is triggered.

Under normal circumstances, there will be certain fluctuations in output(yield). Therefore, a certain threshold can be set for the yield loss rate based on the ideal scenario. When the yield loss rate (Yₗₒₛₛ) is not greater than the predetermined value, it can be considered as normal output fluctuations. The company does not make compensation(payout). When the yield loss rate is greater than the predetermined value, compensation will be made.

According to The grade of year's harvest in grain yields of staple crops (QX/T 335-2016) published by China's government, we set a Yₗₒₛₛ of 4% as a threshold, and the corresponding CCI in each model was the trigger. For example, in Baicheng, there would be no compensation if CCI were lower than 0.34 (the trigger), but insurers would make compensation of a 7% yield loss rate if CCI were 0.4.

The present invitation can form an automatic framework for designing index-based agricultural insurance products, which can save a lot of time for insurance companies to design identical products for different risk zone. Moreover, it can also realize more rapid and accurate disaster loss assessment, and establish a commercialized and automated “index-based agricultural insurance product design” technology system. Meanwhile, the technology also allows insurance companies to predict losses before crops are harvested and to make advance claims payments.

The present invention makes full use of the advantages of multi-source data and crop models. The model is calibrated and validated based on site-level field trial data, which greatly improves the simulation accuracy of yield loss. Besides, it provides technical and scientific support for the design of refined insurance products on a small region.

The embodiment established a vulnerability model for maize chilling with high accuracy at the county level, and calculated the insurance premium rate. As compared with the commonly used single index-based agricultural insurance of “one province, one rate”, it has better loss fitting ability and stronger mechanism.

The present invention combines a multi-source indicator with a crop model system and applies it to exponential agricultural insurance research. The composite index constructed based on multi-source indicators (meteorological indicators and remote sensing indicators) improves the evaluation dimension of index-based insurance, and also solves the problem of inherent simplicity and incomprehensibility. The results of the chilling simulation based on the crop growth model are highly interpretable, which makes up for the shortcomings of the poor quality of the loss data in the agricultural insurance industry. This novel method is an attempt and breakthrough in the research of index agricultural insurance, which can provide new ideas for the design of index agricultural insurance products in the future.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims.

What is claimed is:

1. A method for designing a composite-index agricultural insurance product, comprising the following steps:
S1: Obtaining the required data in a study area, including meteorological data, soil data, field trial data, remote sensing data, and disaster statistics data;
S2: Determining disaster-free years, disaster years, and disaster events in disaster years according to meteorological data and disaster statistics data, generating the ideal climatic scenario as a benchmark by using the mean values of meteorological data during disasters-free years, and building climatic scenarios under disaster by using the Monte Carlo method based on the ideal climatic scenario;
S3: Calibrating the site-level crop growth model by using the field trial data, then inputting the ideal climatic scenario and the climatic scenarios under disaster of S2 into the calibrated crop growth model to get the corresponding output data, and calculating the yield loss rates (Yₗₒₛₛ) of each scenario in each site according to the following Eq.:
$${Y}_{l o s s , k} = \frac{{Y}_{d , k} - {Y}_{i}}{{Y}_{i}} \times 100 \%$$
where Y_{c,k} is the yield under disaster scenario k, Yᵢ is the yield under the ideal scenario, and Y_{loss,k} is the corresponding yield loss rate under disaster scenario k;
S4: Based on the distribution of the yield loss rates, determining the premium rates of agricultural insurance, in which the net rate (μ) is calculated according to the following Eq.:
μ=E[LCR]=E[Yₗₒₛₛ]
where LCR is the loss cost ratio, and E[ . . . ] represents the process of averaging;
S5: Choosing several candidate indicators to characterize the disaster, and calculating the correlation coefficients between each indicator and simulated Yₗₒₛₛ based on the climatic scenarios under disaster and the output data, and based on the magnitude of the correlation, selecting 4 to 6 strong correlation indicators to form a composite index (C/); and
S6: Building a vulnerability model that reflects the response between the yield loss rate and the composite index by using the composite index and the yield loss rate of the climatic scenarios under disaster, and using the vulnerability model to predict the yield loss due to disaster in a specific period and space and determine whether or not making a payout, if making a payout, the amount of payout is calculated based on the premium rate.

2. The method for designing a composite-index agricultural insurance product according to claim 1, wherein the correlation coefficients in step S5 are calculated by a common statistic software—SPSS Statistics.

3. The method for designing a composite-index agricultural insurance product according to claim 1, wherein the premium rate in step S4 includes the risk loading rate (LOAD_{RP}), which is calculated as follows:
LOAD_{RP}=LCR_{RP}−μ
wherein the LCR_{RP} is the loss cost ratio for a specific return period.

4. The method for designing a composite-index agricultural insurance product according to claim 1, wherein the crop is selected from maize, rice, wheat, or soybean.

5. The method for designing a composite-index agricultural insurance product according to claim 1, wherein the composite-index agricultural insurance product is designed for chilling injury, a year in which there is no statistical record of disasters during crop growth period and the absolute value of Anomaly of Growing Degree Days (AGDD) is less than 50 is defined as a disaster-free year; a year in which there is a statistical record of disasters during crop growth period or the Anomaly of Growing Degree Days (AGDD) is less than −50 is defined as a disaster year; and for each disaster year, a day in which the lowest temperature is less than the low threshold temperature for crop growing is defined as a disaster event, that is, a chilling event.

6. The method for designing a composite-index agricultural insurance product according to claim 5, wherein the candidate indicators include the Anomaly of Growing Degree Days (AGDD), Chilling Growing Degree Days (CGDD), the number of days with Tₘᵢₙ Below 2° C. (TB2), and the Anomaly of maximum Leaf Area Index (ALAI).

7. The method for designing a composite-index agricultural insurance product according to claim 1, wherein the composite-index agricultural insurance product is designed for drought; a year in which there is no statistical record of disasters during crop growth period and the Standardized Precipitation Index (SPI) is more than −1 is defined as a disaster-free year; a year in which there is a statistical record of disasters during crop growth period or the Standardized Precipitation Index (SPI) is no more than −1 is defined as a disaster year; and for each disaster year, the case that the number of continuous no-rain days is more than 3 is defined as a disaster event, that is, a drought event.

8. The method for designing a composite-index agricultural insurance product according to claim 7, wherein the candidate indicators include the Standardized Precipitation Index (SPI), the Standardized Soil Moisture Index (SSMI), and Relative Leaf Area Index (RLAI).

9. The method for designing a composite-index agricultural insurance product according to claim 1, wherein in step S6, building the vulnerability model includes utilizing a “curve estimation” module in statistical analysis software SPSS and using the maximum average determination coefficient (R²).

10. The method for designing a composite-index agricultural insurance product according to claim 1, wherein step S2 includes constructing a site-level disaster event frequency and intensity distribution function based on frequency and intensity of the disaster events, and using the distribution function to obtain various simulated disaster scenarios for each site.

11. The method for designing a composite-index agricultural insurance product according to claim 1, wherein in step S6, according to the vulnerability model, when the predicted yield loss rate (Yₗₒₛₛ) is greater than a predetermined value, it is confirmed that a catastrophic crop failure occurs and the payout is made; when the predicted Yₗₒₛₛ is no more than the predetermined value, no payout is made.

12. The method for designing a composite-index agricultural insurance product according to claim 11, wherein the predetermined value is about 4%.

13. A composite-index agricultural insurance product, which is designed and obtained according to the method of claim 1.
